(19) United States
(12) Patent Application Publication
(10) Pub. No.: US 2016/0088151 A1
(43) Pub. Date: Mar. 24, 2016

(54) COMMUNICATION METHOD, APPARATUS, AND SYSTEM

(71) Applicant: Alibaba Group Holding Limited, Grand Cayman (KY)

(72) Inventor: Ping Dai, Hangzhou (CN)

(21) Appl. No.: 14/861,413

(22) Filed: Sep. 22, 2015

(30) Foreign Application Priority Data
Sep. 22, 2014 (CN) 201410487035.2

(51) Int. Cl. H04M 3/42; H04W 8/18; H04L 12/58; H04W 4/12; H04W 4/14

(52) U.S. Cl. CPC H04M 3/42374; H04W 4/12; H04W 4/14; H04L 51/02; H04W 8/183

(57) ABSTRACT

A carrier service server, in response to determining that signals of a called user cannot be searched through a base station, queries a user ID bound to the called number of the called user to send a message indicating that there is an incoming call or a short message to a client terminal corresponding to the user ID via the Internet. The client terminal executes an operation that enables the called user to receive a call or short message content according to a preset configuration. Thus, the called user may, when a communication module for phone signals is closed or there is no mobile communication signal, timely receive the message through the client terminal connected with the Internet.

### CROSS REFERENCE TO RELATED PATENT APPLICATION

This application claims foreign priority to Chinese Patent Application No. 201410487035.2 filed on 22 Sep. 2014, entitled “Communication Method, Apparatus, and System”, which is hereby incorporated by reference in its entirety.

### TECHNICAL FIELD

The present disclosure relates to the field of communications, and, more particularly, to a communication method, apparatus and system.

BACKGROUND

With the rapid development of communication technologies, more and more people are using mobile phones to conduct communication. However, the electromagnetic radiation produced by the frequent interaction between mobile phones at standby state and base stations has been a great concern to people. At present, in order to avoid the radiation produced by the interaction between mobile phones and bases stations, users of the mobile phones may disable communication modules or place themselves in an environment where there is no mobile communication signal, and enable the communication modules or move to an environment where there is a mobile communication signal when it is necessary to make a call.

However, when there is an incoming call or short message when the communication module is closed or there is no mobile communication signal the called users cannot timely receive the call or the short message because the base station cannot locate the called user and the carrier service server will directly notify the calling user that “the telephone number you dialed is powered off.”

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “technique(s) or technical solution(s)” for instance, may refer to apparatus(s), system(s), method(s) and/or computer-readable instructions as permitted by the context above and throughout the present disclosure.

The present disclosure provides a communication method, apparatus and system to enable a called user to timely receive a call or a short message when a communication module of the called user's mobile device, such as a mobile phone, is closed or there is no mobile communication signal.

The present disclosure provides an example communication method, which may be implemented at a carrier service server. For example, the method may include the following operations: in response to determining that a called number of a called user cannot be connected or reached such that a signal of a client terminal of the called user cannot be searched through a base station, querying a user ID bound to the called number of the called user; and sending a message to a client terminal corresponding to the user ID via a network, such as the Internet, in which the message prompts the client terminal, in response to the receipt of the message, to execute an operation that receives a call or a short message initiated by a calling party according to a preset configuration.

The present disclosure also provides a communication apparatus configured at a carrier service server. For example, the communication apparatus may include: a querying unit that, in response to determining that a called number of a called user cannot be connected such that a signal of a client terminal of a called user cannot be searched through a base station, queries a user ID bound to the called number of the called user; and a sending unit that sends a message to a client terminal corresponding to the user ID via a network, such as the Internet, in which the message prompts the client terminal, in response to the receipt of the message, to execute an operation that receives a call or a short message initiated by a calling party according to a preset configuration.

The present disclosure provides a communication method applied at a client terminal. For example, the method may include the following operations: receiving, via a communication network, such as the Internet, a message sent by a carrier service server, in responding to that a called number of a called user cannot be connected such that a signal of the client terminal of the called user cannot be searched through a base station; and executing an operation that receives a call or a short message initiated by a calling party according to a preset configuration.

The present disclosure provides a communication apparatus at a client terminal. For example, the communication apparatus may include: a receiving unit that receives, via a communication network, such as the Internet, a message sent by a carrier service server in responding to that a called number of a called user cannot be connected such that a signal of the client terminal of the called user cannot be searched through a base station; and an executing unit that executes an operation that receives a call or a short message initiated by a calling party according to a preset configuration.

The present disclosure provides a communication system. For example, the communication system may include: a carrier service server and client terminal. The carrier service server, in response to determining that a called number of a called user cannot be connected such that a signal of a client terminal of a called user cannot be searched through a base station, queries a user ID bound to the called number of the called user; and sends a message to a client terminal corresponding to the user ID via a network such as the Internet, in which the message prompts the client terminal, in response to the receipt of the message, to execute an operation that receives a call or a short message initiated by a calling party according to a preset configuration. The client terminal receives, via the communication network such as the Internet, the message sent by the carrier service server, and executes the operation that receives a call or a short message initiated by a calling party according to the preset configuration.

The present disclosure provides an electronic apparatus. For example, the electronic apparatus may include: a first communication unit that enables a user having a first ID to conduct a first communication with another electronic apparatus through a base station, the first communication having a first electromagnetic radiation intensity; a second communication unit that enables the user having a second ID to conduct a second communication with another electronic apparatuses via the Internet, in which the second communication has a second electromagnetic radiation intensity and the second electromagnetic radiation intensity is less than the first electromagnetic radiation intensity; and a processor connected with the first communication unit and the second communication unit that, when the first communication unit cannot be used and the first ID is associated with the second ID, receives a signal or content related to communication of the first ID through the second communication of the second communication unit that replaces the first communication of the first communication unit.

The present disclosure has at least the following beneficial technical effects:

Since the carrier service server, in response to determining that a called user cannot be searched through a base station, queries a user ID bound to called numbers of the called user to send a message used to indicate that there is an incoming call or a short message to a client terminal corresponding to the user ID used by the called user via the Internet, the called user, when the communication module is closed or there is no mobile communication signal, timely receives the message indicating that there is an incoming call or a short message through a client terminal connected with the Internet. After the client terminal executes an operation that enables the called users to receive a call or short message content according to a preset configuration, the called user timely receives the incoming call or short message content.

### BRIEF DESCRIPTION OF THE DRAWINGS

In order to explain technical solutions of the example embodiments of the present disclosure clearly, a brief introduction of drawings to be used for describing the example embodiments is described below. Apparently, the drawings described below merely represent some example embodiments of the present disclosure, and other drawings may be acquired according to these drawings by those skilled in the art without creative efforts.

FIG. 1 is a flowchart of an example communication method applied to a carrier service server according to an example embodiment of the present disclosure.

FIG. 2 is a schematic structural diagram of an example communication apparatus configured on a carrier service server according to an example embodiment of the present disclosure.

FIG. 3 is a flowchart of an example communication method applied to a client terminal according to an example embodiment of the present disclosure.

FIG. 4 is a schematic structural diagram of an example communication apparatus configured on a client terminal according to an example embodiment of the present disclosure.

FIG. 5 is a first schematic structural diagram of an example communication system according to an example embodiment of the present disclosure.

FIG. 6 is a second schematic structural diagram of the example communication system according to an example embodiment of the present disclosure.

FIG. 7 is a schematic structural diagram of an example electronic apparatus according to an example embodiment of the present disclosure.

### DETAILED DESCRIPTION

To help those skilled in the art better understand the technical solutions of the present disclosure, the technical solutions in the example embodiments of the present disclosure are described in the following disclosure with reference to the accompanying drawings in the example embodiments. Apparently, the example embodiments to be described merely represent a part of and not all of the embodiments of the present disclosure. All other embodiments acquired by persons of ordinary skill in the art based on the example embodiments of the present disclosure without creative efforts shall belong to the protection scope of the present disclosure.

Under the conventional techniques, if the base station cannot find the signals of a called number associated with a client terminal of a called user, the called user cannot timely receive a call or short message. Under the techniques of the present disclosure, client terminal software is installed on a terminal device used by the called user, for example, a mobile phone, a computer, a PAD or the like, to bind the called number, such as a mobile phone number of the called user with a user ID (user unique identification) used at the client terminal through a binding setting of the client terminal software. Thus, as long as the terminal device keeps a connection with a communication network such as the Internet through Wi-Fi or Bluetooth, the carrier service server may, when the base station cannot find the signals of the called user, send a message to indicate that there is an incoming call or short message to the client terminal corresponding to the user ID bound to the called number of the called users via the Internet. The client terminal may, according to the received message sent by the carrier service server, execute an operation to enable the called user to receive a call or short message content initiated by a calling party according to a preset configuration.

On the basis of the above analysis, the present disclosure discloses a communication method, apparatus, system and an electronic apparatus as follows.

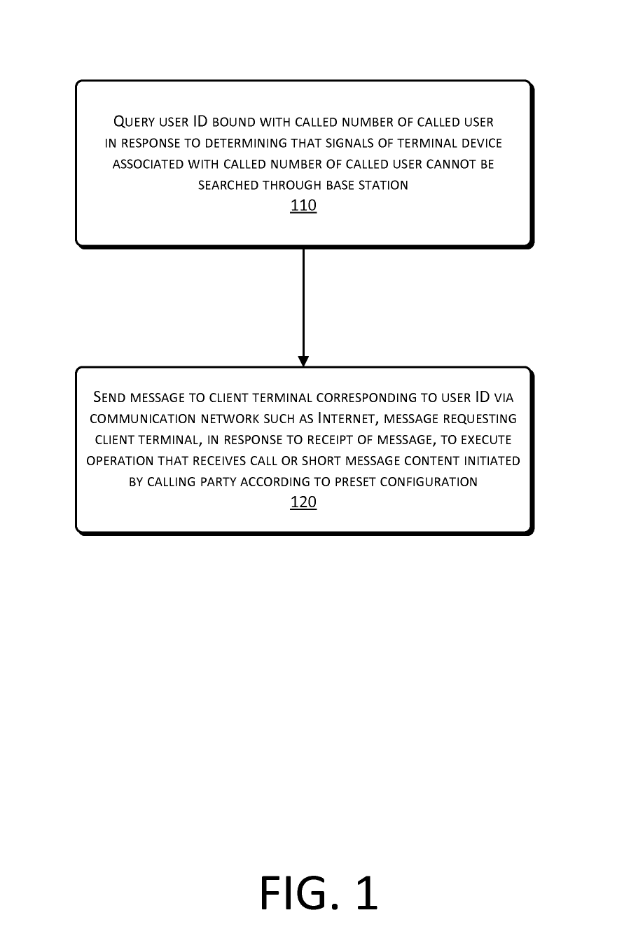

An example embodiment of the present disclosure discloses a communication method applied to a carrier service server. FIG. 1 is a schematic flowchart of the example communication method. As shown in FIG. 1, the communication method may include the following operations.

At 110, in response to determining that signals of a terminal device associated with a called number of a called user cannot be searched through a base station, a user ID bound with the called number of the called user is queried.

For example, the carrier service server may monitor whether sending, by the base station, a call or a short message to the terminal device of the called user corresponding to called numbers fails or not. The carrier service server, in response to determining that the base station cannot find signals of the called number associated with the terminal device of the called user, queries a user ID bound with the called number.

In an example implementation, the carrier service server may receive a request to bind to the called number which is sent by a client terminal corresponding to the user ID, and record a binding relationship between the user ID and the called numbers in a backend database. For example, after the called user uses the user ID to log into a client terminal such as an “Ali Wangwang” instant messaging client terminal, which may run at or be a part of the terminal device, a request to bind the called number with the client terminal may be sent to the carrier service server through the client terminal, and the carrier service server, in response to the receipt of the request from the client terminal, records a binding relationship between the user ID logged into the client terminal and the called number in the background database. Thus, a user ID bound to the called number may be queried in the background database subsequently. In addition, the carrier service server may also receive a request for canceling the binding with the called number sent by the client terminal corresponding to the user ID, and delete or invalidate the binding relationship between the user ID and the called number in the background database.

At 120, a message is sent to a client terminal corresponding to the user ID via a communication network, such as the Internet. The message requests the client terminal, in response to the receipt of the message, to execute an operation that receive a call or short message content initiated by a calling party according to a preset configuration.

For example, the user ID bound to the called number may be a user ID used by the called user to log into the client terminal. The carrier service server may, among all client terminals which keep connections via the Internet, find an IP address of a terminal device on which the client terminal logged into with the user ID bound to the called number is running, and then send a message to the client terminal via the Internet according to the found IP address. Certainly, in the example embodiment of the present disclosure, the client terminal corresponding to the user ID may not be limited to the client terminal logged into with the user ID, and the specific implementation of determining the client terminal corresponding to the user ID may be set according to actual needs, which is not limited in the present disclosure. For example, the client terminal corresponding to the user ID may also be a client terminal logged into with another user ID which has a corresponding relationship with the user ID.

It should be noted that the example embodiment of the present disclosure does not limit the content of the message that the carrier service server sends to the client terminal corresponding to the user ID via the Internet. For example, a particular identification may be added to the message, so that the client terminal, according to the particular identification that exists in the received message, determines that there is an incoming call or short message for the called number, and then executes an operation that enables the called user to receive a call or short message content initiated by a calling party according to a preset configuration. The preset configuration may be set at the client terminal, and there may be one or more preset configurations.

For example, which preset configuration will be adopted to execute the operation that enables the called user to receive a call or short message content initiated by a calling party may be selected by a user at the client terminal, and a user selection may be stored at the client terminal.

Alternatively, the user may also make a selection at the client terminal, and the user selection may be stored at the carrier service server, and the carrier service server sends the user selection of the preset configuration to the client terminal when sending the message.

Whether the user selection of the preset configuration is stored at the client terminal or the carrier service server may be implemented according to practical requirements. For example, if the user selection is stored at the client terminal, there is no need for the carrier service server to send the selection of the preset configuration, which may reduce the amount of data in transmission; if the user selection is stored at the carrier service server, when the user logs into the client terminal on different terminal devices, there is no need to select the preset configuration, which facilitates the user operation.

The example embodiment of the present disclosure does not limit which preset configuration may be adopted to execute the operation that enables the called user to receive a call or short message content initiated by a calling party. For example, in an example implementation of the present disclosure, the preset configuration may be a network call. The carrier service server may also further connect call signals or short message content for the called number to the Internet, and send the call signals or short message content to the client terminal corresponding to the user ID via the Internet to enable the calling party (i.e., calling user) to set up the network call with the called user via the Internet or display the short message content at the client terminal.

As shown, in the method applied to the carrier service server according to the example embodiment of the present disclosure, as long as the terminal device used by the called user keeps a connection with the Internet through Wi-Fi or Bluetooth, when the base station cannot find the called user and cannot connect to the called number, the carrier service server sends a message to indicate that there is a call or an incoming call to a client terminal corresponding to the user ID bound to the called number via the Internet, so that the client terminal may, according to the received message sent by the carrier service server, execute an operation that enables the called user to receive a call or short message content initiated by a calling party according to a preset configuration to make the called user timely receive the call or short message initiated by the calling party.

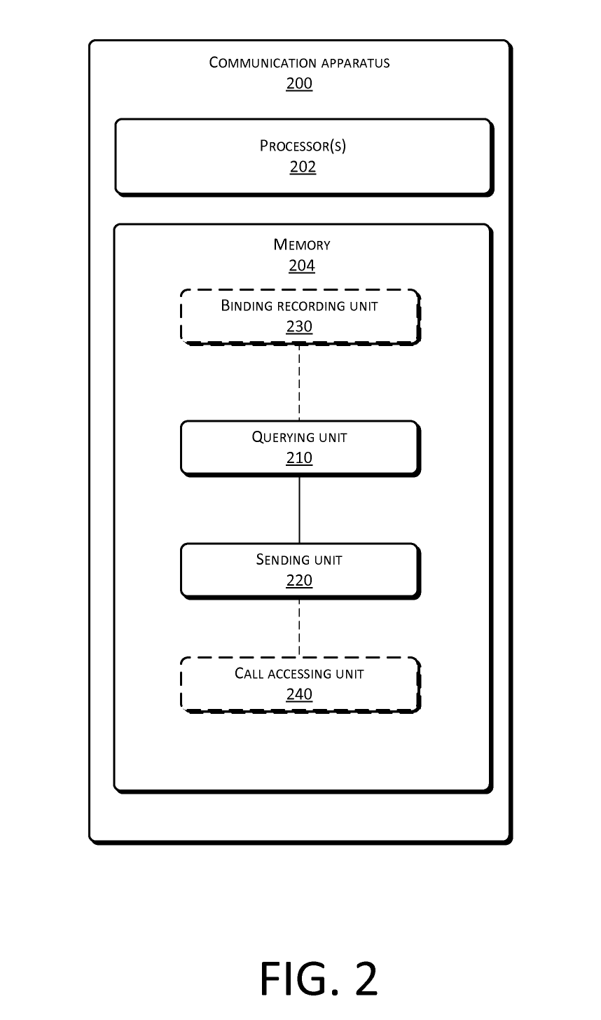

Corresponding to the communication method applied to the carrier service server, another example embodiment of the present disclosure further discloses a communication apparatus configured on a carrier service server. FIG. 2 is a schematic structural diagram of an example communication apparatus 200. As shown in FIG. 2, the communication apparatus 200 may include one or more processor(s) 202 or data processing unit(s) and memory 204. The communication apparatus 200 may further include one or more input/output devices and network interfaces (not shown in FIG. 2).

The memory 204 may include forms such as non-permanent memory, random access memory (RAM), and/or non-volatile memory such as read only memory (ROM) and flash random access memory (flash RAM) in the computer-readable media. The memory 204 is an example of computer-readable media.

The computer-readable media includes permanent and non-permanent, movable and non-ovable media that may use any methods or techniques to implement information storage. The information may be computer-readable instructions, data structure, software modules, or any data. The example of computer storage media may include, but is not limited to, phase-change memory (PCM), static random access memory (SRAM), dynamic random access memory (DRAM), other type RAM, ROM, electrically erasable programmable read only memory (EEPROM), flash memory, internal memory, CD-ROM, DVD, optical memory, magnetic tape, magnetic disk, any other magnetic storage device, or any other non-communication media that may store information accessible by the computing device. As defined herein, the computer-readable media does not include transitory media such as a modulated data signal and a carrier wave.

The memory 204 may store therein a plurality of modules or units including:

a querying unit 210 that, in response to determining that signals of a terminal device associated with a called number of a called user cannot be searched through a base station, queries a user ID bound with the called number of the called users; and

a sending unit 220 that sends a message to a client terminal corresponding to the user ID via a communication network such as the Internet. The message enables the client terminal, in response to the receipt of the message, to execute an operation that enables the called user to receive a call or short message content initiated by a calling party according to a preset configuration.

In an example implementation, the communication apparatus 200 may further include a binding recording unit 230 stored on the memory 204 that receive a request to bind the called number with a user ID, which is sent by the client terminal corresponding to the user ID, and records a binding relationship between the user ID and the called number in a background database.

The example embodiment of the present disclosure does not limit which preset configuration is adopted to execute the operation that enable the called user to receive a call or short message content initiated by a calling party. For example, in an example implementation of the present disclosure, the communication apparatus 200 may further include a call accessing unit 240 that, in response to determining that the preset configuration is a network call, connects call signals or short message content for the called number to the Internet, and sends the call signals or short message content to the client terminal corresponding to the user ID via the Internet.

If the communication apparatus disclosed in the example embodiment of the present disclosure is configured on a carrier service server, when a base station cannot connect with the called number of the called user, the carrier service server may send a message to indicate that there is a call or an incoming call to a client terminal corresponding to the user ID bound with the called number of the called users via the Internet, so that the client terminal may, according to the received message sent by the carrier service server, execute an operation that enables the called user to receive a call or short message content initiated by a calling party according to a preset configuration to make the called user timely receive the call or short message.

For example, the binding recording unit 230 and the call accessing unit 240 according to the embodiment of the present disclosure are drawn with dotted lines in FIG. 2 to indicate that these units are not necessary units of the communication apparatus configured on a carrier service server disclosed in the present disclosure.

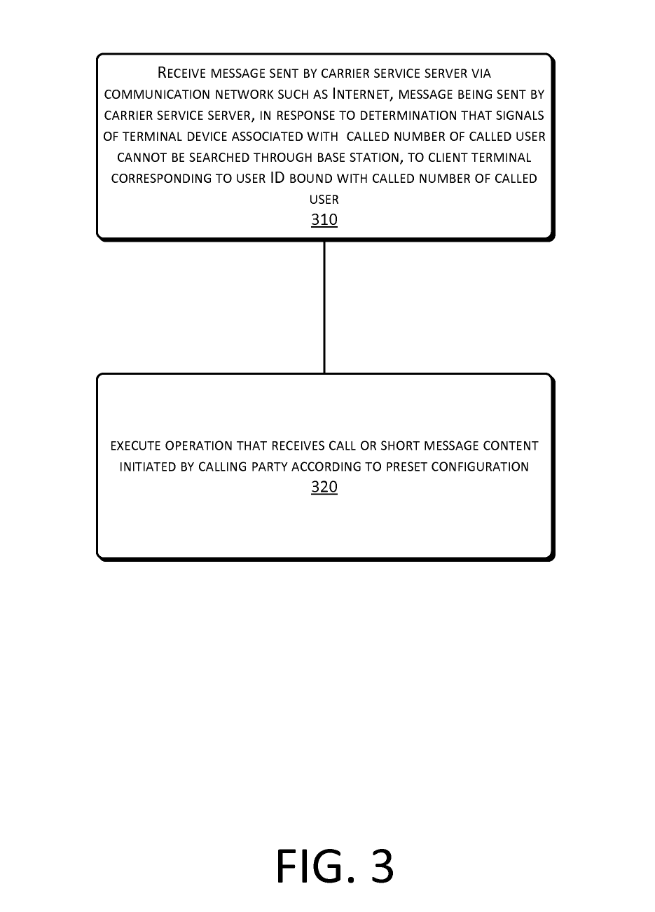

Another example embodiment of the present disclosure discloses a communication method applied to a client terminal at a terminal device. FIG. 3 is a schematic flowchart of the communication method. As shown in FIG. 3, the communication method may include the following operations:

At 310, a message sent by a carrier service server is received via a communication network such as the Internet. The message is sent by the carrier service server, in response to a determination that signals of a terminal device associated with a called number of a called user cannot be searched through a base station, to a client terminal corresponding to a user ID bound with the called number of the called user.

For example, client terminal software installed on a terminal device, for example, a mobile phone, a computer, a PAD or the like, may receive the message sent by the carrier service server when the terminal device on which the client terminal software is running keeps a connection with the Internet through Wi-Fi or Bluetooth.

At 320, an operation that receives a call or short message content initiated by a calling party is executed according to a preset configuration.

For example, according to a message that includes a particular identification, the techniques of the present disclosure determine that the message is sent by the carrier service server, in response to determining that signals of the called number associated with the terminal device of the called user cannot be searched through the base station, to the client terminal corresponding to the user ID bound with the called number of the called user.

The example embodiment of the present disclosure does not limit which preset configuration is adopted to execute the operation used to enable the called user to receive a call or short message content initiated by the calling party. For example, the terminal device used by the called user may be a terminal device that includes a communication module, for example, a mobile phone. When the communication module in the terminal device is closed, the terminal device is in a flight mode. In an example implementation, if the preset configuration is a direct access, an operation of closing the flight mode is executed to enable the communication module of the terminal device on which the client terminal is running, and receive, through the communication module, a call or short message content for the called number initiated by the calling party which is sent by the base station. In another example implementation, the preset configuration may be a network call, and call signals for the called number initiated by the calling party which is sent by the carrier service server are received to set up the network call via the Internet. Alternatively, short message content for the called number initiated by the calling party which is sent by the carrier service server is received at the client terminal via the Internet, and displayed at the client terminal. In a yet another example implementation, the preset configuration may be a message alert, and an alert of a call or short message for the called number is prompted at the client terminal to remind the called user.

In addition, in the implementation that the preset configuration is a direct access, after the call is completed through the communication module or the short message content is received successfully, an operation of opening the flight mode may be executed to return automatically to the flight mode to protect the user from the radiation. The client terminal may call a system function program or a driver to open or close the flight mode. In the implementation where the preset configuration is a network call or message alert, if the client terminal corresponding to the user ID is not in connection with the Internet when the carrier service server sends a message to indicate that there is an incoming call or short message, the carrier service server will send the message to the client terminal corresponding to the user ID again once the client terminal corresponding to the user ID is connected to the Internet, so that the client terminal corresponding to the user ID may acquire short message content via the Internet and display the short message content, or prompt an alert for the call or short message to the called user.

In the example embodiment of the present disclosure, the client terminal may execute an operation that enables the called user to receive a call or short message content initiated by a calling party according to a preset configuration selected from multiple selectable preset configurations. For example, the client terminal may provide a selection interface for selecting any of the three preset configurations, i.e., the direct access, the network call and the message alert, for the user for selection.

For example, the example embodiment of the present disclosure may be applied to an instant messaging client terminal. Using “Ali Wangwang” instant messaging client terminal as an example, after the called user installs the “Ali Wangwang” instant messaging client terminal, a mobile phone number of the called user may be bound with a user ID used to log into the “Ali Wangwang” instant messaging client terminal through the “Ali Wangwang” instant messaging client terminal. The “Ali Wangwang” instant messaging client terminal may, when the terminal device on which the “Ali Wangwang” instant messaging client terminal is running is in connection with the Internet, receive, via the Internet, a message sent by the carrier service server when the carrier service server cannot connect to the called number through the base station. After the “Ali Wangwang” instant messaging client terminal receives the message, the communication module may be enabled by closing a flight mode of the terminal device, and an incoming call or short message for the called number is received through the communication module. After the called user ends the call or receives the short message, the communication module is closed by opening the flight mode of the terminal device. Alternatively, the “Ali Wangwang” instant messaging client terminal may, via the Internet, receive an incoming call for the called number connected by the carrier service server to set up the network call, or receive, via the Internet, short message content with an instant message, and display the received short message content. Alternatively, the “Ali Wangwang” instant messaging client terminal may, according to the received message, prompt an alert for the call or short message to the called user. For example, the alert may include information such as a calling number, call time.

It is understood that the “Ali Wangwang” instant messaging client terminal in the foregoing example embodiment is merely an example implementation where the example embodiment of the present disclosure is applied to an instant messaging client terminal, and is not used to limit the protection scope of the present disclosure.

In addition, in some example implementations, the client terminal in the example embodiment of the present disclosure may, in response to that user execute a calling operation to enable a mobile communication module to send a call signal on a terminal device on which the client terminal is running while the mobile communication module of the terminal device on which the client terminal is running is not available (for example, the terminal device is in a flight mode, the mobile communication module cannot receive mobile signals, and the like), switch the call to the client terminal to send a call to another user with a network phone call.

As shown above, in the method applied to the client terminal disclosed in the example embodiment of the present disclosure, as long as the terminal device used by the called user keeps a connection with the Internet through Wi-Fi, Bluetooth, etc., when the carrier service server cannot connect to the called number of the called user through the base station, the client terminal is capable to, via the Internet, receive a message indicating that there is a call or an incoming message sent by the carrier service server to the client terminal corresponding to a user ID bound with the called number, so that the client terminal may execute an operation that enables the called user to receive a call or short message content initiated by a calling party according to a preset configuration to make the called user timely receive the call or short message.

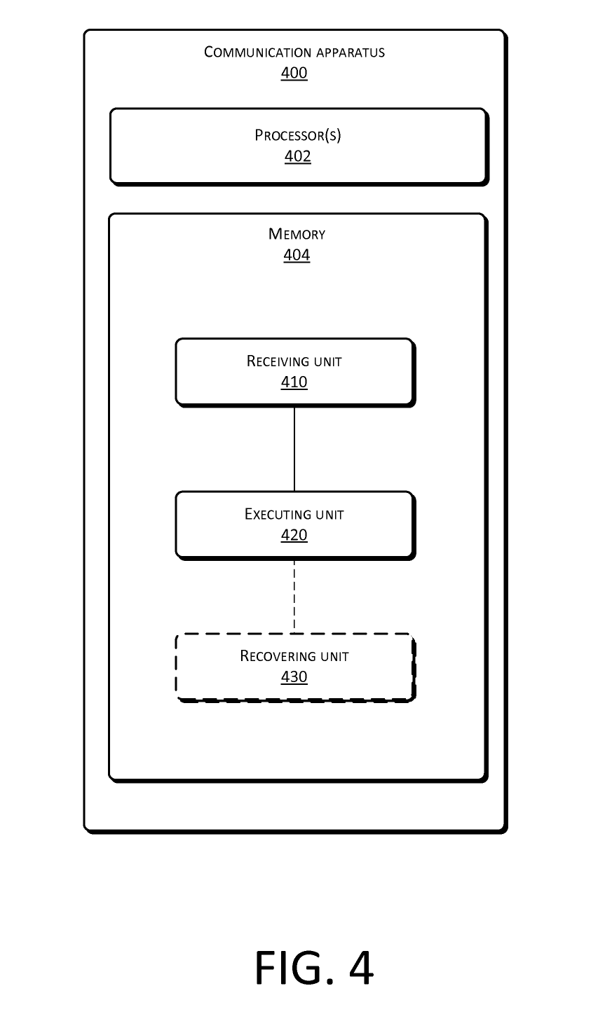

Corresponding to the communication method applied to the client terminal, an example embodiment of the present disclosure further discloses a communication apparatus configured with a client terminal. FIG. 4 is a schematic structural diagram of an example communication apparatus 400. As shown in FIG. 4, the communication apparatus 400 may include one or more processor(s) 402 or data processing unit(s) and memory 404. The communication apparatus 400 may further include one or more input/output devices and network interfaces (not shown in FIG. 4).

The memory 404 is an example of computer-readable media. The memory 404 may store therein a plurality of modules or units including:

a receiving unit 410 that receives, via a communication network such as the Internet, a message sent by a carrier service server; and an executing unit 420 that executes an operation that enables the called user to receive a call or short message content initiated by a calling party according to a preset configuration.

The message is sent by the carrier service server, in response to a determination that signals of a terminal device associated with a called number of a called user cannot be searched through a base station, to a client terminal corresponding to a user ID bound with the called number of the called user.

The example embodiment of the present disclosure does not limit which preset configuration is adopted to execute the operation that enables the called users to receive a call or short message content initiated by a calling party.

For example, if the preset configuration is a direct access, the executing unit 420 may execute an operation of closing a flight mode to enable a communication module of a terminal device on which the client terminal is running, and receive, through the communication module, a call or short message content for the called number initiated by the calling party which is sent by the base station. In the example implementation that the preset configuration is a direct access, the communication apparatus 400 may also include a recovering unit 430 that executes an operation of preventing the terminal device or the communication apparatus 400 from being connected with the carrier service server, such as opening the flight mode after the executing unit 420 receives, through the communication module, a call or short message sent by the base station.

For another example, if the preset configuration is a network call, the executing unit 420 may receive, via the Internet, call signals for the called number sent by the carrier service server to set up a network call, or receive, via the Internet, short message content for the called number sent by the carrier service server, and display the short message content.

For another example, if the preset configuration is a message alert, the executing unit 420 may prompt an alert for a call or short message of the called number to the called user.

In the example embodiment of the present disclosure, the executing unit 420 may select a preset configuration from multiple selectable preset configurations to execute an operation that enables the called user to receive a call or short message content initiated by a calling party.

As shown above, if the communication apparatus disclosed in the example embodiment of the present disclosure is configured with a client terminal, as long as the terminal device used by the called user keeps a connection with the Internet through Wi-Fi, Bluetooth, etc., when the carrier service server cannot connect to the called number through the base station, the client terminal may, via the Internet, receive a message indicating that there is a call or an incoming message sent by the carrier service server to the client terminal corresponding to the user ID bound with the called number, so that the client terminal may execute an operation that enables the called user to receive a call or short message content initiated by a calling party according to a preset configuration to make the called user timely receive the call or short message.

It should be noted that the recovering unit 430 described in the example embodiment of the present disclosure is drawn with dotted lines in FIG. 4 to indicate that the unit is not a necessary unit of the communication apparatus 400 disclosed in the present disclosure.

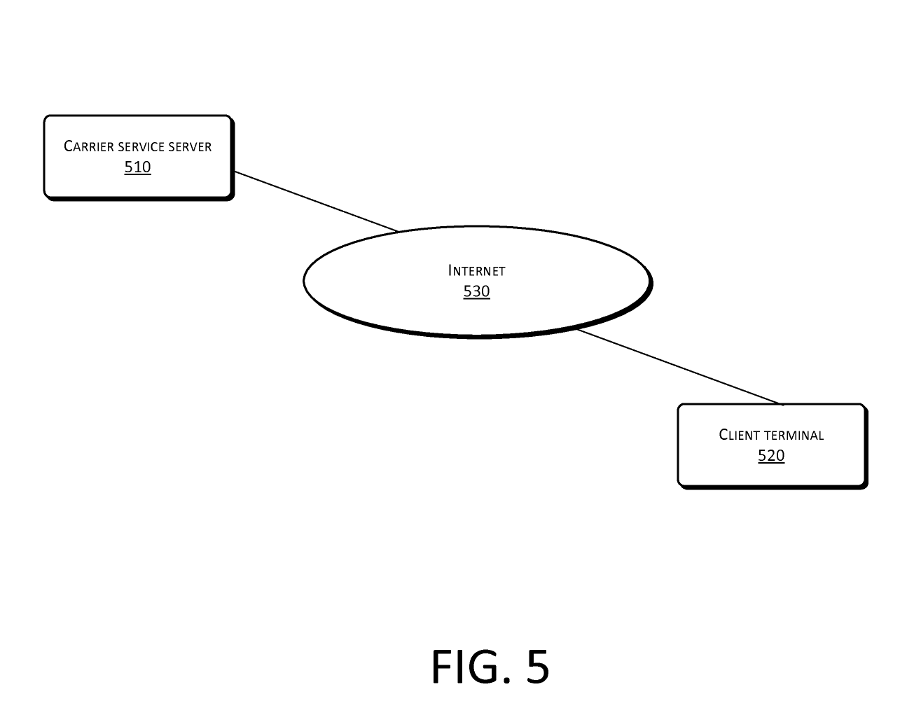

In combination with the communication method applied to the carrier service server and the communication method applied to the client terminal disclosed in the example embodiments of the present disclosure, the present disclosure further discloses an example communication system. FIG. 5 is a schematic structural diagram of an example communication system 500. As shown in FIG. 5, the communication system 500 may include:

a carrier service server 510 that, in response to determining that that signals of a terminal device associated with a called number of a called user cannot be searched through a base station, queries a user ID bound with the called number of the called user, and sends a message to a client terminal 520, at a terminal device, corresponding to the user ID via the Internet. The message enables the client terminal, in response to the receipt of the message, to execute an operation that receives a call or short message content initiated by a calling party according to a preset configuration; and

a client terminal 520 at a terminal device that receives, via the Internet 530, the message sent by the carrier service server, and executes the operation that enable the called user to receive the call or short message content initiated by the calling party according to the preset configuration.

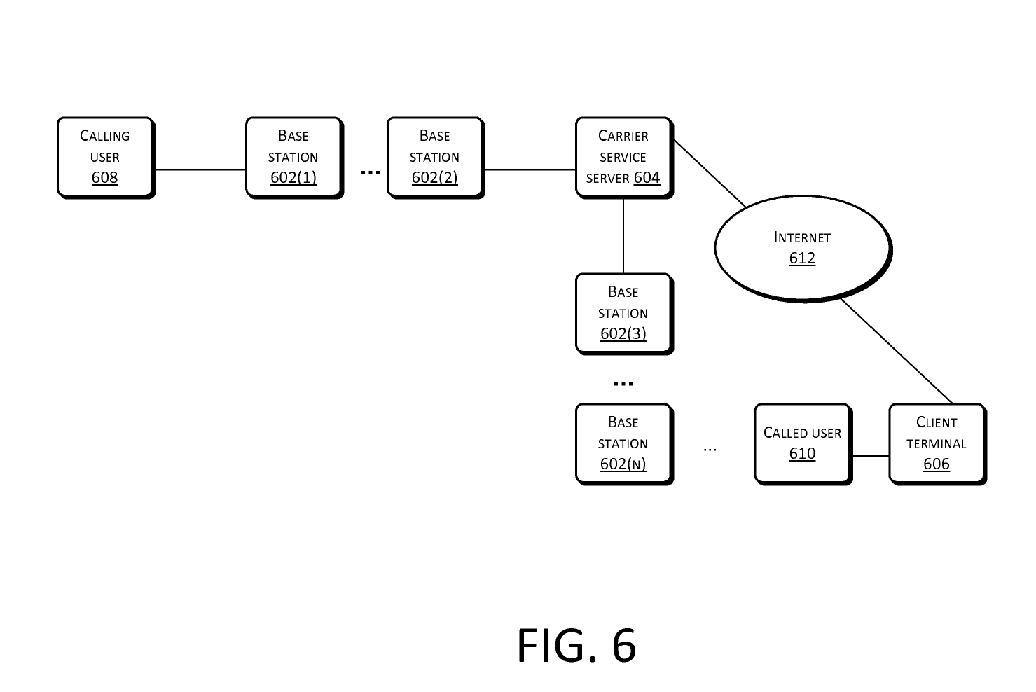

In order to make the example embodiment of the present disclosure more comprehensible, example interactions between one or more base stations 602(1), 602(2), 602(3), 602(n) (n may be any integer) and a carrier service server 604 and between the carrier service server 604 and a client terminal 606 are described below in combination with FIG. 6. For example, as shown in FIG. 6, call signals sent by a calling user 608 for a called number of a called user 610 may be transmitted to a nearby base station 602(1) and then is transferred through layers of base stations, and finally a call request or short message request is transferred to the carrier service server 604. The carrier service server 604 then delivers a call or short message for the called number to the nearby base station. During a process that the layers of base stations transfer the call or short message for the called number, the carrier service server 604 and one or more base stations determine, through information interaction, whether a terminal device of the called user 610 who use the called number has been found or not. If the base station finds the user who use the called numbers, a base station close to the user who use the called number, such as the base station 602(n), sends a call or short message to the terminal device of the called user 610. If the base station cannot find the called user 610 who uses the called number, the carrier service server 604 queries a user ID bound with the called number and sends, via the Internet 612, a message to a client terminal 606 corresponding to the user ID. The client terminal 606 receives, via the Internet 612, the message sent by the carrier service server 604, and executes an operation that enable the called user 610 to receive a call or short message content initiated by the calling user 608 according to a preset configuration, so that the called user 610 may timely receive an incoming call or short message.

In addition, the present disclosure further provides an example electronic apparatus.

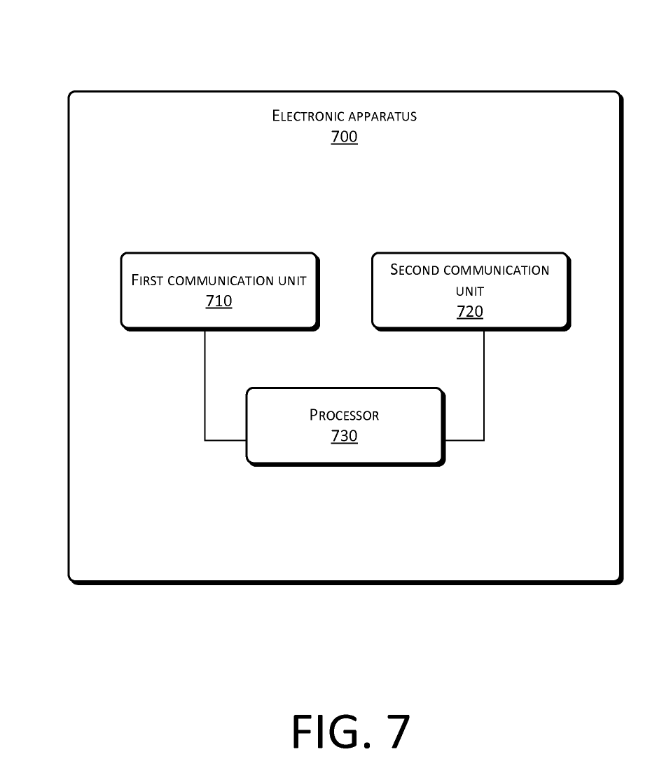

FIG. 7 is a schematic structural diagram of an example electronic apparatus 700 according to an example embodiment of the present disclosure. The electronic apparatus 700 may include one or more input/output devices and network interfaces (not shown in FIG. 7). As shown in FIG. 7, the electronic apparatus 700 may include:

a first communication unit 710 that conducts a first communication with another electronic apparatus for a user at least based on a first identification (ID) of the user via a first communication method such as a mobile phone signal communication through a base station, the first communication having a first electromagnetic radiation intensity;

a second communication unit 720 that conduct a second communication with another electronic apparatuses via a second communication method such as the Internet for the user at least based on a second ID of the user, the second communication having a second electromagnetic radiation intensity, and the second electromagnetic radiation intensity being less than the first electromagnetic radiation intensity; and

a processor 730, connected with the first communication unit 710 and the second communication unit 720, that, when the first communication unit is not used and the first ID is associated with the second ID, receives signals related to the communication of the first ID through the second communication of the second communication unit 720 to replace the first communication of the first communication unit 710.

For example, the first communication unit 710 may be a mobile phone communication unit such as a GSM phone signal communication unit, and the second communication unit 720 may be a Wi-Fi communication unit. An example implementation of receiving the signals related to the communication of the first ID through the second communication of the second communication unit 720 to replace the first communication of the first communication unit 710 may be as follows. Through the Internet communication of the second communication unit 720, the mobile phone communication of the first communication unit 710 is replaced and a call or short message content for the called mobile number is received. Alternatively, a message indicating that a calling party has initiated a call or short message content for the called mobile number is received. Alternatively, after a message indicating that a calling party has initiated a call or short message content for the called mobile number is received, the processor 730 further prompts a reminder to the user.

For convenience of descriptions, the apparatus is described by dividing into various units by function. Certainly, in the implementation of the present disclosure, the functions of the units may be implemented in the same or multiple software and/or hardware.

As shown through the description of the embodiment above, one of ordinary skill in the art may clearly understand that the present disclosure may be realized in the form of software plus the necessary common hardware platform. Based on such an understanding, the technical solution of the present disclosure, intrinsically or with respect to portions that contribute to the conventional techniques, may be realizable in the form of software products. These computer software products may be stored on computer-readable media, such as ROM/RAM, diskettes, and compact discs, and include a certain number of computer-executable instructions that cause one or more computer devices (such as a personal computer, server, or network equipment) to execute the methods described in the embodiments, or certain portions of the embodiments, of the present disclosure.

The example embodiments in this specification are described in a progressive manner, and for identical or similar parts between different example embodiments, reference may be made to each other so that each of the example embodiments focuses on differences from other embodiments. Especially, the example system embodiments are described relatively simple because it is substantially similar to the example method embodiments, and for relevant parts, reference may be made to the example method embodiments.

The present disclosure may be used in many general purpose or specialized computer system environments or configurations, such as personal computers, server computers, handheld devices or portable equipment, tablet type equipment, multiprocessor systems, microprocessor-based systems, set-top boxes, programmable consumer electronic equipment, networked PCs, minicomputers, mainframe computers, distributed computing environments that include any of the systems or equipment above, and so forth.

The present disclosure may be described in the general context of computer-executable instruction executed by a computing device, such as a program module. Generally, program modules include routines, programs, objects, components, data structures, etc. to execute particular tasks or achieve particular abstract data types. The present disclosure may also be carried out in a distributed computing environment. In such distributed computing environments, tasks are executed by remote processing equipment connected via communication networks. In the distributed computing environment, program modules may be located on computer-readable media at local or remote computers that include storage equipment.

It should be noted that, relational terms herein, such as first, second, and the like may be used solely to distinguish one entity or operation from another entity or operation without necessarily requiring or implying any actual relationship or order between such entities or operations. Furthermore, the term “include” and variants thereof are intended to cover non-exclusive inclusion, so that a process, a method, an article or a device includes a series of elements not only includes these elements, but also includes other elements not explicitly listed, or further includes inherent elements of the process, the method, the article or the device. Without further limitation, an element as defined by a statement “including a . . . ” is not exclusive of additional identical elements in the process, the method, the article or the device of the element.

The above descriptions are merely example embodiments of the present disclosure, and are not intended to limit the protection scope of the present disclosure. Any modification, equivalent replacement, improvement or the like made with the spirit and principle of the present disclosure should all be included in the scope of the present disclosure.

What is claimed is:

1. A method, comprising:
determining, by a carrier service server, that a called number of a called user is not reachable;
querying a user identification (ID) bound with the called number; and
sending a message to a client terminal corresponding to the user ID.

2. The method of claim 1, wherein the determining that the called number of the called user is not reachable includes determining that a signal of a terminal device associated with the called number cannot be searched through a base station.

3. The method of claim 1, further comprising:
prior to querying the user ID bound with the called number, receiving a request from the client terminal to bind the user ID with the client terminal; and
recording a binding relationship between the client terminal and the user ID in a database.

4. The method of claim 1, further comprising prompting the client terminal to receive a communication from a calling party according to a preset configuration in response to receiving the message.

5. The method of claim 4, wherein:
the preset configuration is a network call; and
the prompting the client terminal to receive the communication from the calling party according to the preset configuration includes sending a call signal or short message content to the client terminal corresponding to the user ID via Internet.

6. A method, comprising:
receiving a message, from a carrier service server, when a called number of a called user is not reachable; and
executing an operation to receive a communication initiated by a calling party for the called number according to a preset configuration in response to receipt of the message.

7. The method of claim 6, wherein the message is sent by the carrier service server via Internet.

8. The method of claim 6, wherein the called number of the called user is not reachable includes a signal of a terminal device associated with the called number cannot be searched through a base station.

9. The method of claim 6, further comprising:
prompting a selection interface to select the preset configuration from multiple preset configurations.

10. The method of claim 6, wherein:
the present configuration is a direct access; and
the executing the operation to receive the communication initiated by the calling party according to the preset configuration includes:
initiating a communication module of a terminal device to receive phone signals; and
receiving the communication initiated by the calling party via the communication module of the terminal device.

11. The method of claim 10, wherein the initiating the communication module of the terminal device includes turning off a flight mode of the terminal device.

12. The method of claim 10, further comprising:
disabling the communication module of the terminal device after completion of the communication.

13. The method of claim 6, wherein the communication includes a call or a short message.

14. The method of claim 6, wherein:
the preset configuration is a network call; and
the executing the operation to receive the communication initiated by the calling party according to the preset configuration includes:
receiving, via Internet, call signals for the called number initiated by the calling party which are sent by the carrier service server to set up the network call.

15. The method of claim 6, wherein:
the preset configuration is a network call; and
the executing the operation to receive the communication initiated by the calling party according to the preset configuration includes:
receiving, via the Internet, short message content for the called number initiated by the calling party which is sent by the carrier service server; and
displaying the short message content.

16. The method of claim 6, wherein:
the preset configuration is a message alert; and
the executing the operation to receive the communication initiated by the calling party according to the preset configuration includes:
prompting an alert indicating that the calling party has initiated a call or short message content for the called number.

17. The method of claim 6, further comprising:
switching the communication with the calling party via Internet through a client terminal in response to determining that a communication module of a terminal device on which the client terminal resides does not receive phone signals.

18. An electronic apparatus comprising:
a first communication unit that conducts a first communication for a user at least based on a first identification (ID) of the user through a base station, the first communication having a first electromagnetic radiation intensity;
a second communication unit that conducts a second communication for the user at least based on a second ID of the user, the second communication having a second electromagnetic radiation intensity, the second electromagnetic radiation intensity being less than the first electromagnetic radiation intensity; and
a processor that determines that the first communication unit is not used and the first ID is associated with the second ID, and receives signals related to the communication of the first ID through the second communication of the second communication unit.

19. The electronic apparatus of claim 17, wherein the first communication unit is a phone signal communication unit.

20. The electronic apparatus of claim 17, wherein the second communication unit is a Wi-Fi communication unit.
